(19) United States
(12) Patent Application Publication
(10) Pub. No.: US 2012/0284151 A1
(43) Pub. Date: Nov. 8, 2012

(54) DYNAMIC PRICING ADJUSTMENT

(76) Inventor: BROCK C. HIGHAM, Hyrum, UT (US)

(21) Appl. No.: 13/101,305

(22) Filed: May 5, 2011

(51) Int. Cl. G06Q 30/00

(52) U.S. Cl. 705/27.1

(57) ABSTRACT

A method for dynamically adjusting a price of an item offered for sale on a web page may be executed on at least one processor. The method may include setting a starting price as the price for the item and decrementing the price of the item by a downtick for each visit to the web page by a unique visitor until end of sales for the item.

### BACKGROUND OF THE INVENTION

The present invention generally relates to sales, and more particularly relates to dynamic pricing adjustment of goods and services offered for sale.

Currently, online retailing continues to grow in popularity. Generally, items for sale are each listed on an individual web page that a potential buyer can visit to view details about an item for sale as well as to purchase the item. Although a potential buyer is able to easily view details about the item for sale, it is not as easy for a retailer to determine the price that the potential buyer is willing to pay for the item.

As can be seen, there is a need for a method to dynamically adjust the pricing of items offered for sale to make it more likely that the potential buyers will purchase the items.

### SUMMARY OF THE INVENTION

In one aspect of the present invention, a method executing on at least one processor for dynamically adjusting a price of an item offered for sale on a web page, comprising setting a starting price as the price for the item; and decrementing the price of the item by a downtick for each visit to the web page by a unique visitor until end of sales for the item.

These and other features, aspects and advantages of the present invention will become better understood with reference to the following drawings, description and claims.

### BRIEF DESCRIPTION OF THE DRAWINGS

FIG. 1 shows a flowchart of a method for dynamic pricing adjustment in accordance with an embodiment of the present invention; and

FIG. 2 shows a user interface for configuring dynamic pricing adjustment in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide methods for dynamic pricing adjustments of goods and services. Such pricing adjustments may be useful for retailers and businesses that sell their goods and services online on a website.

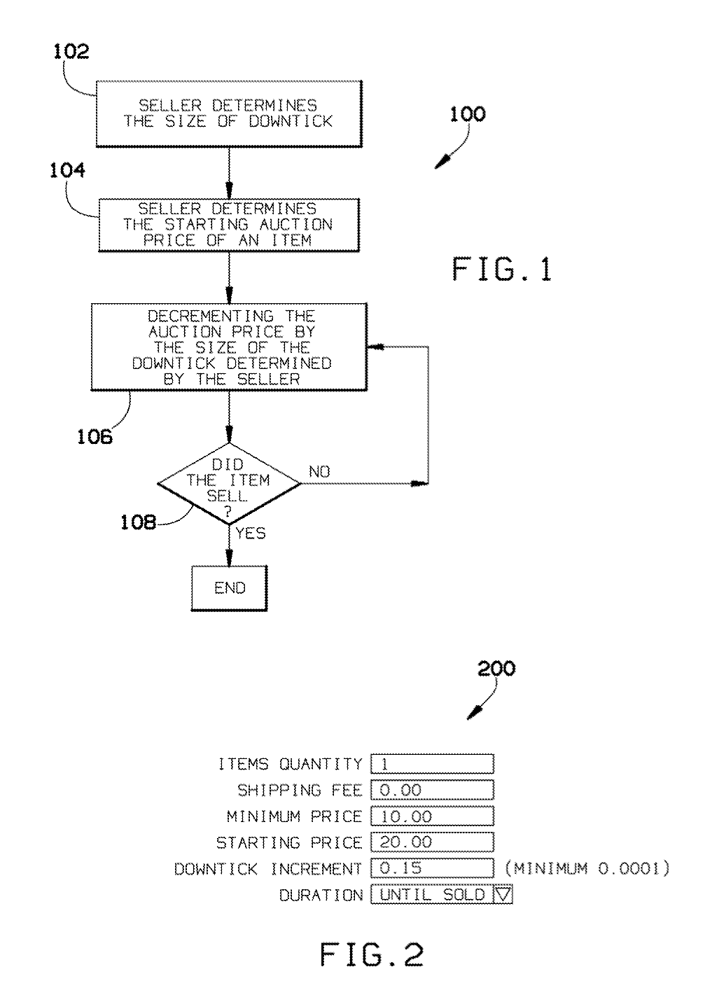

Referring now to FIG. 1, in an exemplary method for dynamic pricing adjustments of goods and services being offered for sale online, such as on a website, the sales price for a good or service may be decremented every time a unique visitor visits the web page where the good or service is listed for sale. Such a method may be executed on one or more processors of a computer system.

The amount that the sales price decrements each time a unique visitor (e.g. by receiving a query from a unique internet protocol address) is detected may be called a downtick. At 102, a seller selling an item may determine the size of the downtick (i.e. the amount that the sales price decrements by for each unique visitor). The downtick may be a specific set number (e.g. $0.15), a percentage of the current price of the item (e.g. 5% of the current price), or a percentage of the starting price of the item (e.g. 10% of the starting price). The size of the downtick may be stored on and retrieved from a computer readable storage medium. At 104, the seller may also determine the starting price of the item, so that, at 106 the starting price may be decremented by the downtick for each visit to the web page where the item is offered for sale from a unique visitor. However, if the visitor is not deemed to be a unique visitor, then the price is not decremented when that visitor visits the page. At 108, if the item was not sold, the price of the good or service may be further decremented by the determined downtick for each successive unique visitor. The decrementing of the sales price may continue the end of sales, which may be met when the item is sold, when a predetermined time period has ended, or when the sales price reaches a predetermined reserve price, at which point the item may be removed from sale and moved to a clearance or junk section of the web site.

In an exemplary embodiment, if a seller starts an auction of an item at a starting price of $10,000, with a 1% drop of the current price of the item as the downtick, the pricing of the item changes as follows:

| | |
|---|---|
| After first unique visitor | $9,900 |
| After second unique visitor | $9,801 |
| After third unique visitor | $9,702.99 |
| After fourth unique visitor | $9,605.96 |
| After fifth unique visitor | $9,509.90 |
| After sixth unique visitor | $9,414.80 |

As shown, the reduction in price with each unique visitor changes for each unique visitor because the 1% drop is based upon the price of the item at the time instead of being based upon the starting price of the item.

Referring now to FIG. 2, an exemplary user interface 200 may be provided to allow a seller of an item to configure the specific dynamic pricing adjustments of the item. As shown in FIG. 2, the user interface, which may be provided as a web page, may allow a seller to configure the item quantity, the shipping fee, the minimum (or reserve) price of the item, the starting price of the item, the downtick size, and the duration of sales for the item.

The present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product, which is a storage medium or computer readable storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

It should be understood, of course, that the foregoing relates to exemplary embodiments of the invention and that modifications may be made without departing from the spirit and scope of the invention as set forth in the following claims.

We claim:

1. A method executing on at least one processor for dynamically adjusting a price of an item offered for sale on a web page, comprising:
setting a starting price as the price for the item; and
decrementing the price of the item by a downtick for each visit to the web page by a unique visitor until end of sales for the item.

2. The method of claim 1, further comprising:
setting a reserve price for the item.

3. The method of claim 2, wherein the decrementing includes decrementing the price of the item by the downtick for each unique visitor until the price reaches the reserve price.

4. The method of claim 1, further comprising:
accepting a size of the downtick.

5. The method of claim 4, wherein the size of the downtick is a set amount of money.

6. The method of claim 4, wherein the size of the downtick is a percentage of the price.

7. The method of claim 1, wherein the unique visitor is a visitor from an internet protocol address that had not previously viewed the web page.

8. The method of claim 1, further comprising:
accepting the starting price for the item.

9. The method of claim 1, wherein the end of sales occurs if the item is sold.

10. The method of claim 1, wherein the end of sales occurs after a predetermined period of time.
